(19) United States
(12) Patent Application Publication
(10) Pub. No.: US 2025/0004267 A1
(43) Pub. Date: Jan. 2, 2025

(54) SYSTEMS AND METHODS FOR DEFLECTING OPTICAL BEAMS BY TRANSLATING METASURFACES

(71) Applicant: CORNING INCORPORATED, CORNING, NY (US)

(72) Inventors: Erik Michael Allan Busby, Castro Valley, CA (US); Michael John Yadlowsky, Sunnyvale, CA (US)

(21) Appl. No.: 18/704,513

(22) PCT Filed: Oct. 14, 2022
(86) PCT No.: PCT/US2022/046644

§ 371 Date: Apr. 25, 2024

Related U.S. Application Data
(60) Provisional application No. 63/273,176, filed on Oct. 29, 2021.

(51) Int. Cl. G02B 26/08; G02B 1/00; G02B 3/00; G02B 26/10

(52) U.S. Cl. CPC G02B 26/0808; G02B 1/002; G02B 3/0006; G02B 26/0875; G02B 26/101

(57) ABSTRACT

A system for deflecting an optical beam is provided. The system includes a first substrate, a first metasurface fabricated on a surface of the first substrate, a second substrate substantially parallel with the first substrate, a second metasurface fabricated on a surface of the second substrate, and an actuator configured to translate one of the first substrate and the second substrate relative to the other of the first substrate and the second substrate by a first translation distance in a first direction parallel to the surface of the first substrate and the surface of the second substrate. The first translation distance corresponds to a first target deflection angle of the optical beam.

### CROSS-REFERENCE TO RELATED APPLICATIONS

This application claims the benefit of priority under 35 U.S.C. § 119 of U.S. Provisional Application No. 63/273,176 filed Oct. 29, 2021, the content of which is incorporated herein by reference in its entirety.

### FIELD

The present specification generally relates to systems and methods for deflecting an optical beam, and more particularly, systems and methods for deflecting an optical beam by translating a metasurface relative to another metasurface.

### TECHNICAL BACKGROUND

Beam scanning technology is widely used in modern optics. There are many ways to scan or deflect a beam. The majority of implementations are reflective, wherein a beam is scanned by reflecting the beam off of a mirror with variable tip and/or tilt. In practice, this technique typically is accomplished using a galvomirror or a polygon scanner. A galvomirror is a mirror attached to an actuator like a servo, stepper, motor etc. The mirror is then tilted by engaging the actuator in either resonant or non-resonant motion. Alternatively, polygon scanners can be used. In this implementation, a multi-sided polygonal mirror is placed in a beam path and rotated. The rotation allows for fast, continuous speed beam scanning.

While these and other implementations of beam scanning are ubiquitous hardware in modern optics, their form factors are limited to relatively large device footprints and track lengths. While this does not present a significant problem for barcode scanners, small form factors are becoming increasingly important as photonics are incorporated into smaller and/or less obtrusive devices. This is particularly challenging for mobile applications like smart phones and tablets, which are increasingly using more advanced near infrared (NIR) photonics for facial recognition and LIDAR for 3D imaging and ranging.

There are a few limiting factors that determine the form factor of a given scanning device. The geometry is limited by the mode of deflection, i.e., reflection versus transmission. Additionally the range of motion that the device requires will further limit how small a device can be, i.e., a polygon scanner will require enough space to house the polygon in all possible angles of rotation, as would a galvo scanner. The supporting motors, bearings, etc. also increase the footprint of the resultant device. Additionally reflection geometry is often not conducive to device integration into a single board device.

Microlens array beam scanners have been implemented. However, the field of view (FoV) of a microlens array beam scanner has been limited to ˜10°. This is largely due to the limited numerical aperture (NA) of refractive lens arrays fabricated using known methods. Additionally, these microlens array beam scanners suffer from poor spatial fill factor, which results in decreased device efficiencies. This is due to conventional microlens fabrication techniques generally using a circular lens footprint in a square or hexagonal grid. The inefficiency of circles packing into a regular lattice results directly in a proportional throughput efficiency loss and/or increased aberrations resulting from the increased lens cross-sections in some direction.

Therefore, there is a need for a small footprint for a relatively wide field of view (FoV) beam scanner.

### SUMMARY

A first aspect of the present disclosure includes a system for deflecting an optical beam comprising: a first substrate; a first metasurface fabricated on a surface of the first substrate; a second substrate substantially parallel with the first substrate; a second metasurface fabricated on a surface of the second substrate; and an actuator configured to translate one of the first substrate and the second substrate relative to the other of the first substrate and the second substrate by a first translation distance in a first direction parallel to the surface of the first substrate and the surface of the second substrate. The first translation distance corresponds to a first target deflection angle of the optical beam.

A second aspect of the present disclosure includes the system according to the first aspect, wherein each of the first metasurface and the second metasurface are patterned such that each of the first metasurface and the second metasurface has optical characteristics substantially equivalent to characteristics of cylindrical lenses.

A third aspect of the present disclosure includes the system according to any of the first through second aspects, wherein each of the first surface and the second surface are patterned such that each of the first metasurface and the second metasurface has optical characteristics substantially equivalent to characteristics of either spherical lenses or aspherical lenses.

A fourth aspect of the present disclosure includes the system according to the third aspect, wherein the actuator is further configured to translate one of the first substrate and the second substrate relative to the other of the first substrate and the second substrate by a second translation distance in a second direction orthogonal to the first direction and parallel to the surface of the first substrate and the surface of the second substrate; and the second translation distance is determined based on a second target deflection angle of the optical beam.

A fifth aspect of the present disclosure includes the system according to any of the first aspect to the fourth aspect, wherein: first metasurface is separated from the second metasurface by an optical gap extending in a third direction orthogonal to the first metasurface and the second metasurface.

A sixth aspect of the present disclosure includes the system according to the fifth aspect, wherein the optical gap between the first metasurface and the second metasurface corresponds to a sum of a focal length of the first substrate with the first metasurface and a focal length of the second substrate with the second metasurface.

A seventh aspect of the present disclosure includes the system according to the sixth aspect, wherein the gap is less than 50 microns.

An eighth aspect of the present disclosure includes the system according to any of the first through seventh aspects, wherein a numerical aperture of the first metamaterial is about 0.2 and a numerical aperture of the second metamaterial is about 0.6.

A ninth aspect of the present disclosure includes the system according to any of the first through eighth aspects, further comprising: a memory storing a lookup table including amounts of translations of the first substrate or the second substrate and corresponding deflection angles of an optical beam; and a processor programmed to determine the first translation distance based on the first target deflection angle of the optical beam and the lookup table.

A tenth aspect of the present disclosure includes the system according to the fourth aspect, further comprising: a memory storing a lookup table including amounts of translations of the first substrate or the second substrate and corresponding deflection angles of an optical beam; and a processor programmed to: determine the first translation distance based on the first target deflection angle of the optical beam and the lookup table; and determine the second translation distance based on the second target deflection angle of the optical beam and the lookup table.

An eleventh aspect of the present disclosure includes the system according to any of the first through tenth aspects, further comprising: a spacer disposed between the first metasurface and the second metasurface.

A twelfth aspect of the present disclosure includes the system according to any of the first through eleventh aspects, further comprising: a lens array disposed on another surface of the second substrate.

A thirteenth aspect of the present disclosure includes the system according to the twelfth aspect, wherein the lens array is disposed in a focal plane of the first substrate with the first metasurface.

A fourteenth aspect of the present disclosure includes the system according to the twelfth aspect, wherein the lens array is configured to deflect beamlets from the first metasurface to be incident upon the second metasurface.

A fifteenth aspect of the present disclosure includes a method for deflecting an optical beam comprising: directing an optical beam towards a beam deflector comprising a first substrate, a first metasurface comprising a first metamaterial and disposed on a surface of the first substrate, a second substrate, and a second metasurface comprising a second metamaterial and disposed on a surface of the second substrate; and
translating, by an actuator, one of the first substrate and the second substrate relative to the other of the first substrate and the second substrate by a first translation distance in a first direction parallel to the surface of the first substrate and the surface of the second substrate. The first translation distance is determined based on a first target deflection angle of the optical beam.

A sixteenth aspect of the present disclosure includes the method according to the fifteenth aspect, further comprising: translating, by the actuator, one of the first substrate and the second substrate relative the other of the first substrate and the second substrate by a second translation distance in a second direction orthogonal to the first direction and parallel to the surface of the first substrate and the surface of the second substrate; and the second translation distance is determined based on a second target deflection angle of the optical beam.

A seventeenth aspect of the present disclosure includes the method according to any of the fifteenth through sixteenth aspects, wherein: first metasurface is separated from the second metasurface by an optical gap extending in a third direction orthogonal to the first metasurface and the second metasurface.

An eighteenth aspect of the present disclosure includes the method according to the seventeenth aspect, wherein the optical gap between the first metasurface and the second metasurface corresponds to a sum of a focal lengths of the first substrate with the first metasurface and a focal length of the second substrate with the second metasurface.

A nineteenth aspect of the present disclosure includes the method according to the fifteenth aspect, further comprising: determining the first translation distance based on the first target deflection angle of the optical beam and a lookup table including amounts of translations of the first substrate or the second substrate and corresponding deflection angles of an optical beam.

A twentieth aspect of the present disclosure includes the method according to the sixteenth aspect, further comprising: determining the first translation distance based on the first target deflection angle of the optical beam and a lookup table including amounts of translations of the first substrate or the second substrate and corresponding deflection angles of an optical beam; and determining the second translation distance based on the second target deflection angle of the optical beam and the lookup table.

It is to be understood that both the foregoing general description and the following detailed description are merely exemplary and are intended to provide an overview or framework to understand the nature and character of the claims. Additional features and advantages will be set forth in the detailed description which follows, and in part will be readily apparent to those skilled in the art from the description or recognized by practicing the embodiments as described in the written description and claims hereof, as well as the appended drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a system for deflecting an optical beam according to one or more embodiments shown and described herein;

FIG. 2A depicts deflection of beams by translating one of substrates, according to one or more embodiments shown and described herein;

FIG. 2B depicts deflection of beams by translating one of substrates, according to one or more embodiments shown and described herein;

FIG. 3A depicts an example layout of the transmit lens displayed for a square footprint lens array, according to one or more embodiments shown and described herewith;

FIG. 3B depicts an example layout of the receive lens displayed for a square footprint lens array, according to one or more embodiments shown and described herewith;

FIG. 4 depicts beam deflection results of numerical (finite-difference time-domain) modeling;

FIG. 5 depicts a flowchart for deflecting beam by translating a lens having a metasurface, according to one or more embodiments shown and described herein;

FIG. 6A depicts a three lens array system, according to another embodiments shown and described herein;

FIG. 6B depicts a three lens array system, according to another embodiments shown and described herein; and

FIG. 7 depicts a metamaterial implementation of the three lens array system shown in FIGS. 6A and 6B.

### DETAILED DESCRIPTION

Reference will now be made in detail to embodiments of systems and methods for deflecting an optical beam by translating a metasurface relative to another metasurface. In embodiments, a metamaterial-based beam scanning system includes a first metasurface fabricated on a first substrate, a second metasurface fabricated on a second substrate, and an actuator. The actuator translates one of the first substrate and the second substrate relative to the other of the first substrate and the second substrate by a first translation distance in a first direction parallel to the surface of the first substrate and the surface of the second substrate. Various embodiments of systems and methods for deflecting an optical beam will be described herein in further detail with specific reference to the appended drawings.

The present beam scanning system may angularly deflect an incident beam by a user-configurable angle. Each of the first surface and the second surface may be based on transmissive metamaterials optimized for beam deflection. A metamaterial is an optical element consisting of a substrate with sub-wavelength features that are precisely fabricated to yield an optical surface with properties (phase delay, transmission, wavelength response, bandwidth, etc.) that are tailored for the desired application of beam deflection. The substrates and the structures fabricated thereon can consist of a variety of materials, for example, a substrate of glass or silicon and a fabricated layer of amorphous silicon, TiO₂, or another high refractive index, low loss material.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the specific value or end-point referred to is included. Whether or not a numerical value or end-point of a range in the specification recites “about,” two embodiments are described: one modified by “about,” and one not modified by “about.” It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation. Further, as used herein, the singular forms “a,” “an” and “the” include plural referents unless the context clearly dictates otherwise. Thus, for example, reference to “a” component includes aspects having two or more such components, unless the context clearly indicates otherwise.

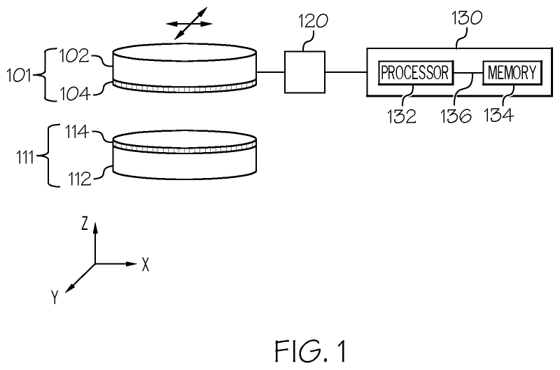

Referring now to FIG. 1, schematically depicted is a system for deflecting an optical beam according to one or more embodiments shown and described herein. The system includes a first substrate 102, a first metasurface 104, a second substrate 112, a second metasurface 114, and an actuator 120. The system may be used to angularly deflect an input beam by a user-configurable angle by translating one of the first metasurface 104 and the second metasurface 114 by a first translation distance in a first direction parallel to the surface of the first substrate and the surface of the second substrate.

The first metasurface 104 is fabricated on the surface of the first substrate 102. The second metasurface 114 is fabricated on the surface of the second substrate 112. The first metasurface and the second metasurface may be made of matermaterials. The metamaterials may include artificial materials with their optical properties determined by patterned sub-wavelength structures. In contrast to natural materials whose refractive indices are determined by atomic and molecular responses to external electromagnetic waves, metamaterials' effective refractive indices are locally defined by high-index sub-wavelength structures, which allow spatial control of the transmissive or reflective phase in a predetermined manner. In embodiments, the first metasurface 104 may comprise any appropriate metamaterial working in the visible to infrared wavebands, such as metamaterials including metals (e.g., gold, silver, and aluminum) and dielectrics (e.g., silicon, titanium dioxide, and silicon nitride). It is noted that the first metasurface 104 may be manufactured with predetermined thicknesses via lithography and nanofabrication techniques. The first substrate 102 and the second substrate 112 may consist of a variety of materials such as glass or silicon.

In embodiments, the first metasurface 104 may be referred as a receive surface and the second metasurface 114 may be referred as a transmit surface. Each of the first metasurface 104 and the second metasurface 114 may be designed such that each of the first metasurface 104 and the second metasurface 114 functions approximately like microlens arrays.

The first substrate 102 and the first metasurface 104 constitute a receive lens 101 and the combination of the second substrate 112 and the second metasurface 114 constitute a transmit lens 111 may implement a variety of lens profiles, including spherical, aspherical, and cylindrical profiles. Using 2-dimensional lens profiles, such as spherical and aspherical profiles, may create a deflector that may function in two dimensions, allowing X/Y translation of the receive lens 101 to cause independent θ/φ deflection of a beam. A polar angle θ (theta) is an angle with respect to a polar axis, i.e., z axis in FIG. 1, and azimuthal angle φ is an angle of rotation from an initial meridian plane, i.e., the x-y plane in FIG. 1.

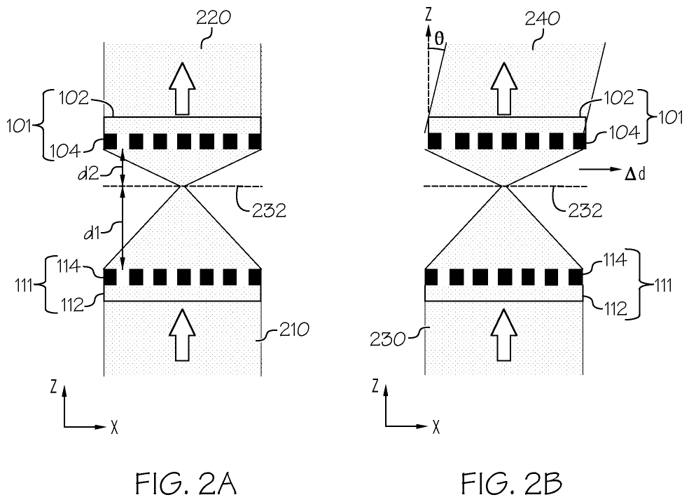

Use of cylindrical lenses can create a 1-dimensional deflector that similarly functions in a single axis. In embodiments, the transmit lens 111 acts to subsection an incoming light source into an array of beamlets and focus the beamlets into a grid of focal spots in a common plane such as a beamlet focal plane 232 in FIG. 2A. It may be desirable to use an aspherical lens profile because the design flexibility of metamaterials allows for such a profile without incurring additional fabrication costs.

The actuator 120 may be any actuator that is configured to mechanically move the first substrate 102 relative to the second substrate 112. For example, the actuator 120 may be a motor or a solenoid actuator. While FIG. 1 discloses that the actuator 120 is connected to the first substrate 102, the actuator 120 may be connected to the second substrate 112 to move the second substrate 112 relative to the first substrate 102. In some embodiments, the actuator 120 may be connected to both the first substrate 102 and the second substrate 112 to move the first substrate 102 and the second substrate 112 simultaneously or independently.

The actuator 120 is coupled to a processing device, such as computing device 130. Computing device 130 may include any device or combination of components comprising a processor 132 and non-transitory computer readable memory 134. The processor 132 may be any device capable of executing the machine-readable instruction set stored in the non-transitory computer readable memory 134. Accordingly, the processor 132 may be an electric controller, an integrated circuit, a microchip, a computer, or any other computing device. The processor 132 is communicatively coupled to the other components of a beam deflector by the communication bus 136. Accordingly, the communication bus 136 may communicatively couple any number of processors 132 with one another, and allow the components coupled to the communication bus 136 to operate in a distributed computing environment. It is further noted that the processor 132 may comprise a single processor, multiple processors, or a system of processors.

The non-transitory computer readable memory 134 may comprise RAM, ROM, flash memories, hard drives, or any non-transitory memory device capable of storing machine-readable instructions such that the machine-readable instructions can be accessed and executed by the processor 132. The machine-readable instruction set may comprise logic or algorithm(s) written in any programming language of any generation (e.g., 1GL, 2GL, 3GL, 4GL, or 5GL) such as, for example, machine language that may be directly executed by the processor 132, or assembly language, object-oriented programming (OOP), scripting languages, microcode, etc., that may be compiled or assembled into machine readable instructions and stored in the non-transitory computer readable memory 134. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. It is noted that the non-transitory computer readable memory 134 may include one or more devices, memory modules, or the like. The non-transitory computer readable memory 134 may include a lookup table including amounts of translations of the first substrate 102 or the second substrate 112 and corresponding deflection angles of an optical beam.

In embodiments, the computing device 130 may obtain a beam scanning profile. For example, a user may enter a desired beam scanning profile including ranges of deflection angles θ and φ. The computing device 130 may determine amounts of translations of the first substrate 102 or the second substrate 112 based on the lookup table and the beam scanning profile. Then, the computing device 130 controls the actuator 120 according to the determined amounts of translations to move the first substrate 102 or the second substrate 112 to deflect beams. For example, the second substrate 112 is fixed at the current position, and the actuator 120 may move the first substrate 102 in the +x/−x direction or in the +y/−y direction based on the determined amounts of translation. The distance between the first substrate 102 and the second substrate 112 in the z direction is fixed while the first substrate 102 moves in the x-y plane relative to the second substrate 112. As another example, the first substrate 102 is fixed at the current position, and the actuator 120 may move the second substrate 112 in the +x/−x direction or in the +y/−y direction based on the determined amounts of translation. The distance between the first substrate 102 and the second substrate 112 in the z direction is fixed while the second substrate 112 moves in the x-y plane. As another example, the actuator 120 may move both the first substrate 102 and the second substrate 112 in their respective x-y planes based on the determined amounts of translation.

FIGS. 2A and 2B depict deflection of beams by translating one of the substrates, according to one or more embodiments shown and described herein.

Referring to FIG. 2A, input beam 210 passes through the transmit lens 111 including the second substrate 112 and the second metasurface 114. After passing through the transmit lens 111, the beam focuses on a beamlet focal plane 232. The distance d1 between the second metasurface 114 and the beamlet focal plane 232 in the z direction is a focal length of the transmit lens 111.

The receive lens 101 including the first substrate 102 and the first metasurface 104 is positioned in a confocal geometry with the transmit lens 111 such that the receive lens 101 is positioned one focal length from the beamlet focal plane 232. Specifically, the distance d2 between the first metasurface 104 and the beamlet focal plane 232 in the z direction is a focal length of the receive lens 101. The receive lens 101 outputs an exiting beam 220. In this example, the exiting beam 220 propagates in the same direction as the input beam 210. The optical gap between the first metasurface 104 and the second metasurface 114 corresponds to a sum of the focal length of the receive lens 101 with the first metasurface 104 and the focal length of the transmit lens 111 as adjusted to account for materials in the optical path. The optical gap in this example may be between about 10 microns and about 2.5 millimeters. In some embodiments, the optical gap may be less than 50 microns. In some embodiments, the optical gap may include the thickness of the first substrate 102 and/or the second substrate 112.

By referring to FIG. 2B, the receive lens 101 including the first substrate 102 and the first metasurface 104 is translated in the +x direction by an amount of Δd to deflect an exiting beam 240. The translation of the receive lens 101 may be controlled by the actuator 120 in FIG. 1. In this case, the exiting beam 240 propagates in a different direction from the propagation of input beam 230. When the receive lens 101 is translated in the x direction while maintaining the distance between the receive lens 101 and the transmit lens 111 in the z direction, the exiting beam 240 will be deflected by an angle θ proportional to the translation of the receive lens 101 in the x direction. The exiting beam 240 may have the same divergence behavior as the input beam 230, scaled for any net magnification in the system. Thus, in the present system, a collimated input would result in a similarly collimated output. Practically, the characteristic of the exiting beam 240 is limited by the metamaterial quality, the beamlet size and the ratio of the focal lengths of the microlenses in the scanner.

While FIG. 2B depicts translating the receive lens 101 in the x direction, the receive lens 101 may be translated in the x or y direction as shown in FIG. 1. For example, the receive lens 101 may be translated in the +y direction shown in FIG. 1. In response to the translation of the receive lens 101 in y direction, the exiting beam 240 deflects toward the +y direction by azimuthal angle φ. The amount of azimuthal angle φ may be proportional to the amount of the translation of the receive lens 101 in the y direction.

In some embodiments, the transmit lens 111 instead of the receive lens 101 may be translated in the x or y direction. In some embodiments, both the receive lens 101 and the transmit lens may be translated simultaneously or independently.

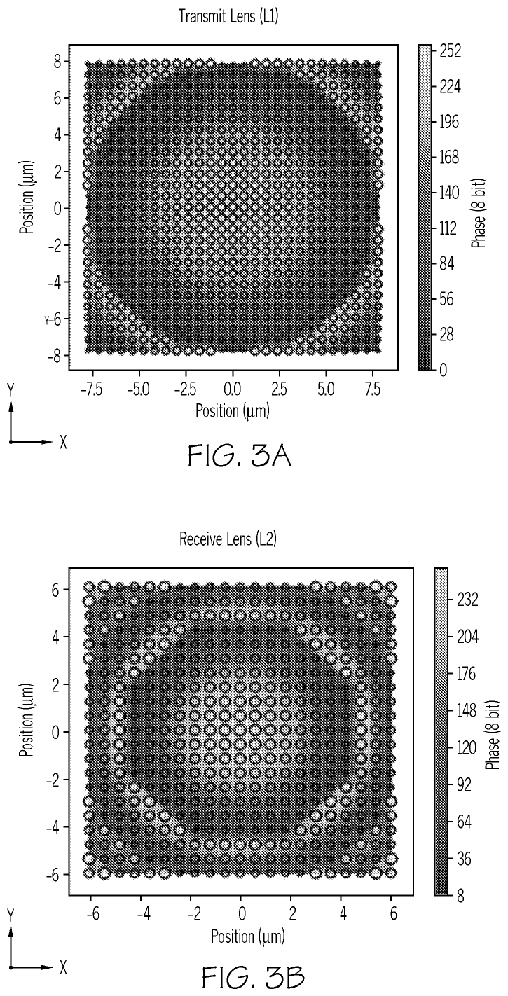

FIGS. 3A and 3B depict example layouts of the transmit lens and the receive lens displayed for a 12 μm square footprint lens array, according to one or more embodiments shown and described herewith. The transmit lens 111 may have a numerical aperture (NA) of about 0.2, and the receive lens 101 may have a numerical aperture (NA) of about 0.6. The plots show the post structures plotted atop the gradient of the target phase profile (shown on an 8-bit scale, 0-255 with a range of 0-2π).

In contrast with conventional microlens array beam scanners, the metamaterials used in the present disclosure are capable of very high numerical apertures (e.g., some demonstrations show numerical apertures of nearly unity), fill factors that are approaching unity and phase profiles that can reduce spherical and other aberrations over large lens cross-sections.

The system of the present disclosure is one example of the function of a more general class of beam deflectors. For purposes demonstration, a 12 μm square lattice is modeled. This system consists of the transmit lens 111 having a 0.2 NA transmit lens and a receive lens 101 having a 0.6 NA. It is modeled as a single lens pair, as that is the smallest functional unit of the design capable of being modeled. The present system may be optimized for telecom bands of about 1550 nm.

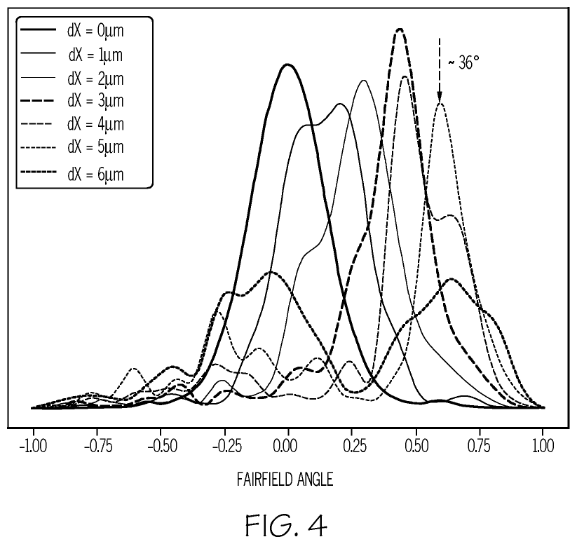

FIG. 4 depicts beam deflection results of numerical (finite-difference time-domain) modeling. The x axis in FIG. 4 is the intensity of the exiting beam and the y axis in FIG. 4 indicates the angle of deflection of the exiting beam in Farfield Angle. FIG. 4 shows multiple plots corresponding to different translations of the receive lens 101. Specifically, seven plots corresponding to different translations are depicted in FIG. 4. When the translation of the receive lens is 0, i.e., dX=0 μm, the peak intensity of the exiting beam is at 0 degrees of deflection. As the translation increases, the deflection degree of the exiting beam also increases as illustrated in FIG. 4. The maximum deflection degree of the exiting beam is about 36 degrees when the translation of the receive lens 101 becomes 5 μm. That is, even if the translation of the receive lens 101 becomes greater than 5 μm, e.g., 6 μm, the deflection degree of the exiting beam does not increase over 36 degrees. In some embodiments, the beam may distort or begin another deflection cycle as it interacts with the next lens in the array such that the deflection degree of the beam may be further adjusted.

This demonstration shows ±36 degrees of deflection, which is more than 3 times greater field of view than an equivalent conventional optical system. This amount of deflection is accomplished with a 12 μm range of motion of a receive lens or a transmit lens, which further helps to keep the motion allowance from increasing the footprint of a final beam deflecting device. The modeling results presented in FIG. 4 demonstrate proof of concept, displaying one of many possible configurations. The system may be tailored to specific applications. This includes the option to select the lens let size for the array and the focal length. Larger lenses may give better beam quality. A longer focal length may reduce tolerances in the lenses but proportionally more range of motion will be required. The metasurface design may also be optimized for the target wavelength(s).

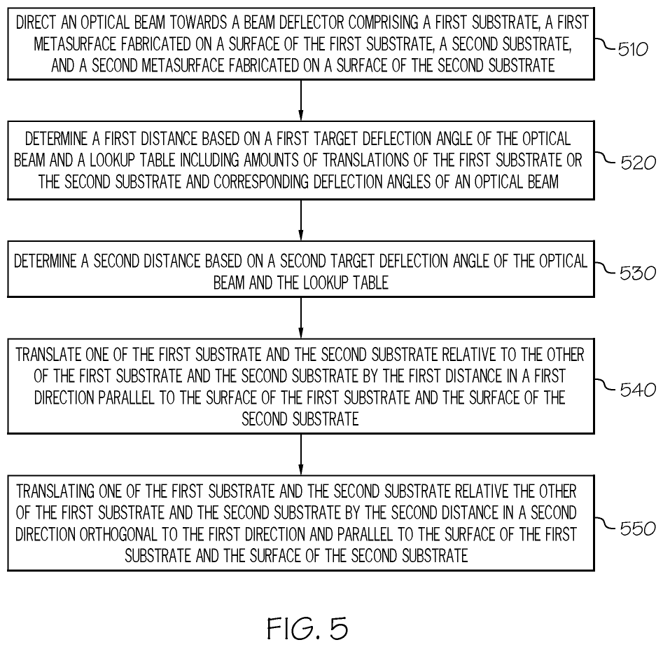

FIG. 5 depicts a flowchart for deflecting a beam by translating a lens having a metasurface, according to one or more embodiments shown and described herein.

In step 510, an optical beam is directed towards a beam deflector comprising a first substrate, a first metasurface fabricated on a surface of the first substrate, a second substrate, and a second metasurface fabricated on a surface of the second substrate. For example, the beam deflector may be the beam deflector shown in FIG. 1.

In step 520, a computing device determines a first translation distance based on a first target deflection angle of the optical beam and a lookup table including amounts of translations of the first substrate or the second substrate and corresponding deflection angles θ of an optical beam. In embodiments, by referring to FIG. 1, the computing device 130 determines a first translation distance based on a first target deflection angle of the optical beam and a lookup table stored in the memory 134. The lookup table may include amounts of translations of the first substrate 102 or the second substrate 112 and corresponding deflection angles θ of an optical beam. The first translation distance may be an amount of translation of the first substrate 102 or the second substrate 112 in the +x/−x direction.

Referring back to FIG. 5, in step 530, the computing device determines a second translation distance based on a second target deflection angle φ of the optical beam and the lookup table. Referring to FIG. 1, in embodiments, the computing device 130 determines a second translation distance based on a second target deflection angle φ of the optical beam and the lookup table stored in the memory 134. The second translation distance may be an amount of translation of the first substrate 102 or the second substrate 112 in the +y/−y direction.

Referring back to FIG. 5, in step 540, the computing device instructs the actuator to translate one of the first substrate and the second substrate relative to the other of the first substrate and the second substrate by the first translation distance in a first direction parallel to the surface of the first substrate and the surface of the second substrate. Referring to FIG. 1, in embodiments, the computing device 130 may instruct the actuator 120 to translate the first substrate 102 relative to the second substrate 112 by the first translation distance in a first direction, e.g., the +x direction.

Referring back to FIG. 5, in step 550, the computing device translates one of the first substrate and the second substrate relative the other of the first substrate and the second substrate by the second translation distance in a second direction orthogonal to the first direction and parallel to the surface of the first substrate and the surface of the second substrate. Referring to FIG. 1, in embodiments, the computing device 130 may instruct the actuator 120 to translate the first substrate 102 relative to the second substrate 112 by the second translation distance in a second direction, e.g., the ty direction.

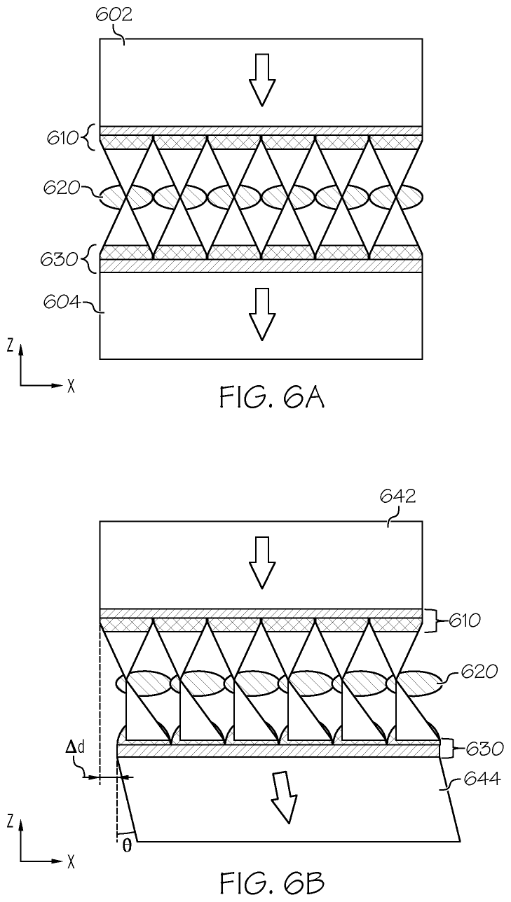

FIGS. 6A and 6B depict a three lens array system, according to other embodiments shown and described herein.

Referring to FIG. 6A, a three lens array system includes: a transmit lens array 610, an intermediate lens array 620, and a receive lens array 630. Each of the transmit lens array 610, the intermediate lens array 620, and the receive lens array 630 include multiple lenses disposed therein. The transmit lens array 610 includes a substrate and a metasurface similar to the receive lens 101 in FIG. 1. Similarly, the receive lens array 630 includes a substrate and a metasurface similar to the receive lens 111. The intermediate lens is placed in the focal plane of the transmit lens array 610 and in the focal plane of the receive lens array 630.

The transmit lens array 610 receives input beam 602, outputs beamlets, and focuses the beamlets in the focal plane of the transmit lens array 610. The intermediate lens array 620 deflects the beamlets from the transmit lens array 610 to ensure that the beamlets are incident on the appropriate location on the receive lens array 630 throughout the full range of motion. The receive lens array 630 outputs exiting beam 604. In FIG. 6A, the transmit lens array 610, the intermediate lens array 620, and the receive lens array 630 are aligned such that the exiting beam 604 propagates in the same direction as the input beam 602.

Referring to FIG. 6B, the intermediate lens array 620 and the receive lens array 630 translate in the +x direction by an amount Δd to deflect exiting beam 644. The translation of the intermediate lens array 620 and the receive lens array 630 may be controlled by an actuator similar to the actuator 120 in FIG. 1. In this case, the exiting beam 644 propagates in a different direction from the input beam 642. Specifically, the exiting beam 644 is deflected from the z axis direction by an angle θ. When the intermediate lens array 620 and the receive lens array 630 are translated in the x direction while maintaining the distance between the receive lens array 610 and the intermediate lens array 620 in the z direction and the distance between the intermediate lens array 620 and the receive lens array 630 in the z direction, the exiting beam 644 may be deflected by an angle proportional to the amounts of the translations of the intermediate lens array 620 and the receive lens array 630. The exiting beam 644 may have the same divergence behavior as the input beam 642, scaled for any net magnification in the system. Thus, a collimated input would result in a similarly collimated output. While FIG. 6B depicts translating the intermediate lens array 620 and the receive lens array 630 in the x direction, the intermediate lens array 620 and the receive lens array 630 may be translated in the x or y direction as shown in FIG. 1. In some embodiments, the combination of the transmit lens array 610 and the intermediate lens array 620 instead of the combination of the intermediate lens array 620 and the receive lens array 630 may be translated in the x or y direction.

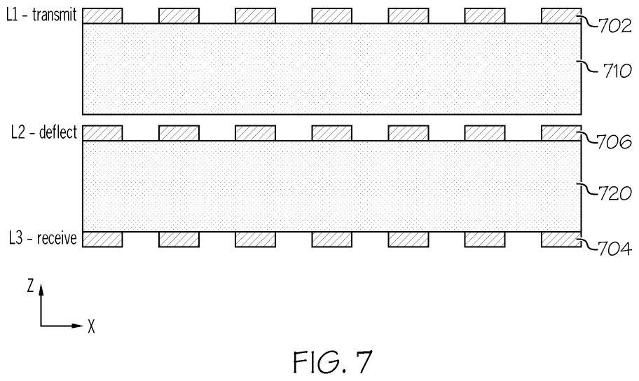

FIG. 7 depicts a metamaterial implementation of the three lens array system shown in FIGS. 6A and 6B. In this design, the first metasurface 702 or a transmit metasurface is patterned on a first substrate 710 and the second metasurface 704 and the third metasurface 706 are patterned on opposite sides of a second substrate 720. In embodiments, an actuator similar to the actuator 120 in FIG. 1 may translate the second substrate 720 in the x-y plane. Because the second metasurface 704 and the third metasurface 706 are patterned on the same substrate, the second metasurface 704 and the third metasurface 706 move together in the x or y direction. The three lens array system shown in FIGS. 6A, 6B and 7 may be used to minimize the effects of beamlets clipping on the receive lens array when the receive lens array is translated to the extrema of its travel relative to the transmit lens array.

The system described above is a flat metasurface adaptation of an array of lens pairs working as Keplerian telescopes. In some embodiments, it is also possible to construct a similar system in a Galilean telescope configuration with the receive lens array constructed from negative focal length lenses. In this embodiment, the function is qualitatively the same as the Keplerian design described above, but the confocal position no longer involves a real image plane between the lens pairs. This allows the design to function in an afocal condition with a smaller inter-surface spacing. This smaller spacing can be an advantage in some implementations of a scanning mechanism to translate the metamaterials relative to each other.

Metamaterials also provide the option of designing polarization dependent functions into optical devices. The devices discussed above are designed to function independent of input polarization. In some embodiments, differing functions for different input polarization may be utilized. This includes varying parameters like lens focal length, the magnification factor of the lenslet pairs, or the effective pitch of the lens array.

In addition to the optically active surfaces, the mechanical requirements of the beam deflection system may also be designed into the fabricated surfaces. This may include integrating spacers into the optically inactive periphery surrounding the metasurface. These spacers may be used to maintain a constant spacing between the two metasurfaces. The spacers may also be designed to slide against one another to provide for inter-surface translation. Alternately, spacers that are shorter than the required inter-layer spacing may be integrated as a fail-safe measure to prevent the two optical metasurfaces from contacting one another and potentially sustaining damage.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

It will be apparent to those skilled in the art that various modifications and variations can be made to the embodiments described herein without departing from the spirit and scope of the claimed subject matter. Thus, itis intended that the specification cover the modifications and variations of the various embodiments described herein provided such modification and variations come within the scope of the appended claims and their equivalents.

What is claimed is:

1. A system for deflecting an optical beam, the system comprising:
a first substrate;
a first metasurface fabricated on a surface of the first substrate;
a second substrate substantially parallel with the first substrate;
a second metasurface fabricated on a surface of the second substrate; and
an actuator configured to translate one of the first substrate and the second substrate relative to the other of the first substrate and the second substrate by a first translation distance in a first direction parallel to the surface of the first substrate and the surface of the second substrate,
wherein the first translation distance corresponds to a first target deflection angle of the optical beam.

2. The system of claim 1, wherein each of the first metasurface and the second metasurface are patterned such that each of the first metasurface and the second metasurface has optical characteristics substantially equivalent to characteristics of cylindrical lenses.

3. The system of claim 1, wherein each of the first metasurface and the second metasurface are patterned such that each of the first metasurface and the second metasurface has optical characteristics substantially equivalent to characteristics of either spherical lenses or aspherical lenses.

4. The system of claim 3, wherein the actuator is further configured to translate one of the first substrate and the second substrate relative to the other of the first substrate and the second substrate by a second translation distance in a second direction orthogonal to the first direction and parallel to the surface of the first substrate and the surface of the second substrate; and
the second translation distance is determined based on a second target deflection angle of the optical beam.

5. The system of claim 1, wherein:
the first metasurface is separated from the second metasurface by an optical gap extending in a third direction orthogonal to the first metasurface and the second metasurface.

6. The system of claim 5, wherein the optical gap between the first metasurface and the second metasurface corresponds to a sum of a focal length of the first substrate with the first metasurface and a focal length of the second substrate with the second metasurface.

7. The system of claim 6, wherein the optical gap is less than 50 microns.

8. The system of claim 1, wherein a numerical aperture of the first metasurface is about 0.2 and a numerical aperture of the second metamaterial is about 0.6.

9. The system of claim 1, further comprising:
a memory storing a lookup table including amounts of translations of the first substrate or the second substrate and corresponding deflection angles of an optical beam; and
a processor programmed to determine the first translation distance based on the first target deflection angle of the optical beam and the lookup table.

10. The system of claim 4, further comprising:
a memory storing a lookup table including amounts of translations of the first substrate or the second substrate and corresponding deflection angles of an optical beam; and
a processor programmed to:
determine the first translation distance based on the first target deflection angle of the optical beam and the lookup table; and
determine the second translation distance based on the second target deflection angle of the optical beam and the lookup table.

11. The system of claim 1, further comprising:
a spacer disposed between the first metasurface and the second metasurface.

12. The system of claim 1, further comprising:
a lens array disposed on another surface of the second substrate.

13. The system of claim 12, wherein the lens array is disposed in a focal plane of the first substrate with the first metasurface.

14. The system of claim 12, wherein the lens array is configured to deflect beamlets from the first metasurface to be incident upon the second metasurface.

15. A method for deflecting an optical beam, the method comprising:
directing an optical beam towards a beam deflector comprising a first substrate, a first metasurface fabricated on a surface of the first substrate, a second substrate, and a second metasurface fabricated on a surface of the second substrate; and
translating, by an actuator, one of the first substrate and the second substrate relative to the other of the first substrate and the second substrate by a first translation distance in a first direction parallel to the surface of the first substrate and the surface of the second substrate,
wherein the first translation distance is determined based on a first target deflection angle of the optical beam.

16. The method of claim 15, further comprising:
translating, by the actuator, one of the first substrate and the second substrate relative the other of the first substrate and the second substrate by a second translation distance in a second direction orthogonal to the first direction and parallel to the surface of the first substrate and the surface of the second substrate; and
the second translation distance is determined based on a second target deflection angle of the optical beam.

17. The method of claim 15, wherein:
the first metasurface is separated from the second metasurface by an optical gap extending in a third direction orthogonal to the first metasurface and the second metasurface.

18. The method of claim 17, wherein the optical gap between the first metasurface and the second metasurface corresponds to a sum of a focal lengths of the first substrate with the first metasurface and a focal length of the second substrate with the second metasurface.

19. The method of claim 15, further comprising:
determining the first translation distance based on the first target deflection angle of the optical beam and a lookup table including amounts of translations of the first substrate or the second substrate and corresponding deflection angles of an optical beam.

20. The method of claim 16, further comprising:
determining the first translation distance based on the first target deflection angle of the optical beam and a lookup table including amounts of translations of the first substrate or the second substrate and corresponding deflection angles of an optical beam; and
determining the second translation distance based on the second target deflection angle of the optical beam and the lookup table.
